(19) United States
(12) Patent Application Publication
(10) Pub. No.: US 2025/0091668 A1
(43) Pub. Date: Mar. 20, 2025

(54) LINK AND TRACK

(71) Applicant: Caterpillar SARL, Geneva (CH)

(72) Inventors: Seiji IIJIMA, Akashi-shi (JP); Yasuo YAMASHITA, Akashi-shi (JP); Yu MATSUMOTO, Akashi-shi (JP); Chad M. Arnold, Peoria, IL (US)

(73) Assignee: Caterpillar SARL, Geneva (CH)

(21) Appl. No.: 18/884,364

(22) Filed: Sep. 13, 2024

(30) Foreign Application Priority Data
Sep. 14, 2023 (JP) 2023-149444

(51) Int. Cl. B62D 55/088; B62D 55/06; B62D 55/12; B62D 55/21

(52) U.S. Cl. CPC B62D 55/088; B62D 55/062; B62D 55/211; B62D 55/12

(57) ABSTRACT

Problems: Provided is a link capable of effectively discharging earth and sand and a track including the same. Solutions: A link is mounted on a shoe and used in a link device. The link has a hole portion for earth removal formed by cutting out a side portion facing the shoe so as to divide an installation surface to the shoe into a plurality of parts in a rotating direction of the shoe.

### FIELD OF THE INVENTION

The present invention relates to a link used in a track and the track including the same.

### BACKGROUND OF THE INVENTION

In the related art, tracks used in tracked vehicles such as hydraulic excavators include a link device including links coupled together endlessly, and shoe plates mounted on the links and stretched over the link device. When such a tracked vehicle travels on muddy ground, a track periphery may become covered in earth and sand. It is necessary to remove the earth and sand by washing the vehicle, but the tracks on the ground have two parallel rows of links with the shoe plates at a bottom, making it difficult to remove the earth and sand since the earth and sand and water tend to accumulate between the links. Some shoe plates have earth removal holes, but if the earth and sand gets stuck under the shoe plates, it becomes difficult to remove the earth and sand.

For example, some links have openings to reduce a weight or to place nuts that fastening bolts fixing the shoe plates (see, for example, Patent Document 1). Although such openings in the links can be used for discharging the earth and sand accumulated between the links, there is a height from a shoe plate mounting surface to the opening, and thus the earth and sand and the water tend to remain between the links even after cleaning. In particular, when an attachment such as a rubber pad that blocks the earth removal hole in the shoe plate is attached, the earth and sand is discharged only through the opening on the link side, and thus the earth and sand may not be discharged effectively. Further, there is also a concern that the attachment is damaged by a pressure of the earth and sand from the earth removal hole in the shoe plate.

A link device is known in which a hole portion including a threaded portion for screwing a bolt is formed in the link to fix the shoe plate (see, for example, Patent Document 2). With this configuration, there is no need for an opening to dispose a nut fastening the bolt, and thus there is no need to provide an opening in the link. In particular, when the link is manufactured from a flat plate or a rolled material, forming an opening requires a processing step, so that the opening may not be provided. If no openings are provided in the links as described above, it is difficult to remove the earth and sand, and if the vehicle travels with the earth and sand stuck between the links, a part of a lower traveling body may wear out or become damaged, or the track may come off.

### PRIOR ART DOCUMENTS

### Patent Documents

Patent Document 1: JP2004-249797A
Patent Document 2: JP2015-525705A

### SUMMARY OF THE INVENTION

### Problems to be Solved by the Invention

As described above, it is required to be able to effectively discharge earth and sand.

The present invention has been made in view of these points, and an object thereof is to provide a link capable of effectively discharging earth and sand and a track including the same.

### Means for Solving the Problem

The invention according to claim 1 is a link on which a rotating member is mounted and which is used in a link device, the link including a hole portion for earth removal formed by cutting out a side portion facing the rotating member so as to divide an installation surface to the rotating member into a plurality of parts in a rotating direction of the rotating member.

The invention according to claim 2 is the link according to claim 1, the link further including a bolt hole portion which is opened on each of the installation surfaces divided by the hole portion on the side portion facing the rotating member and into which a mounting bolt that mounts the rotating member is screwed.

The invention according to claim 3 is a track including a link device in which a plurality of the links according to claim 1 or 2 are endlessly coupled; and a shoe, which is the rotating member mounted on the side portion of each link.

The invention according to claim 4 is the track according to claim 3, in which the shoe has a groove-shaped removal portion on a surface facing the link, and the link and the shoe are mounted such that the hole portion and the removal portion communicate with each other.

### Effect of the Invention

According to the invention according to claim 1, the earth and sand can be effectively discharged through the notch.

According to the invention according to claim 2, the rotating member can be easily mounted through the bolt hole portion.

According to the invention according to claim 3, the track can be provided that is inexpensive and has good maintenance properties against the earth and sand.

According to the invention according to claim 4, the opening for discharging earth and sand can be made large, and for example, when the track is washed, water that flows into the removal portion can be discharged through the hole portion that opens a side surface, making it easier to discharge the earth and sand.

### BRIEF DESCRIPTION OF THE DRAWINGS

FIG. 1 is a longitudinal cross-sectional side view showing a first embodiment of links and a track including the same according to the present invention.

FIG. 2 is a longitudinal cross-sectional front view showing a part of the track.

FIG. 3 is a perspective view showing a part of the track.

FIG. 4 is a side view showing a tracked vehicle equipped with the track.

FIG. 5 is a longitudinal cross-sectional side view showing a second embodiment of links and a track including the same according to the present invention.

FIG. 6 is a longitudinal cross-sectional side view showing a third embodiment of links and a track including the same according to the present invention.

FIG. 7 is a longitudinal cross-sectional side view showing a fourth embodiment of links and a track including the same according to the present invention.

### DETAILED DESCRIPTION

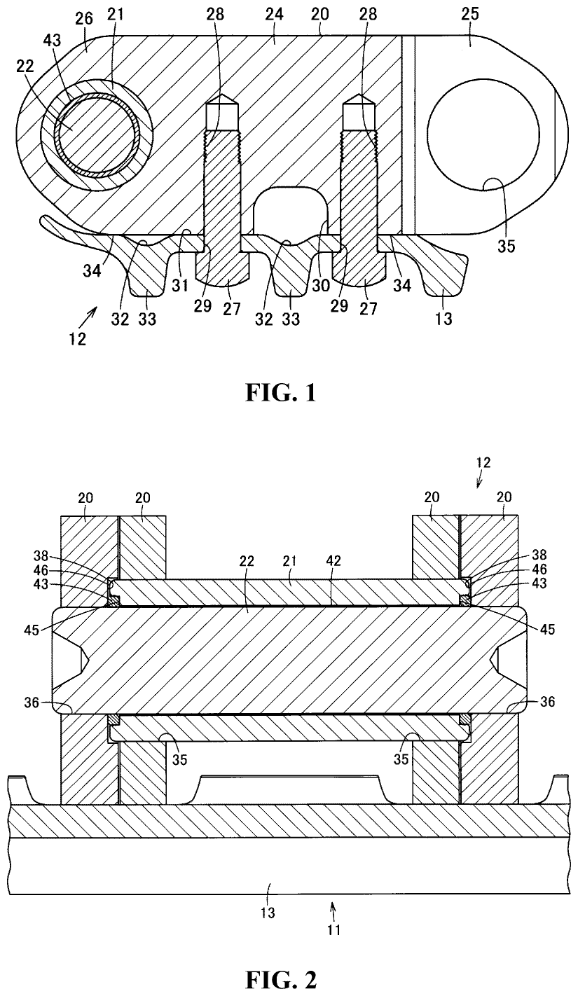

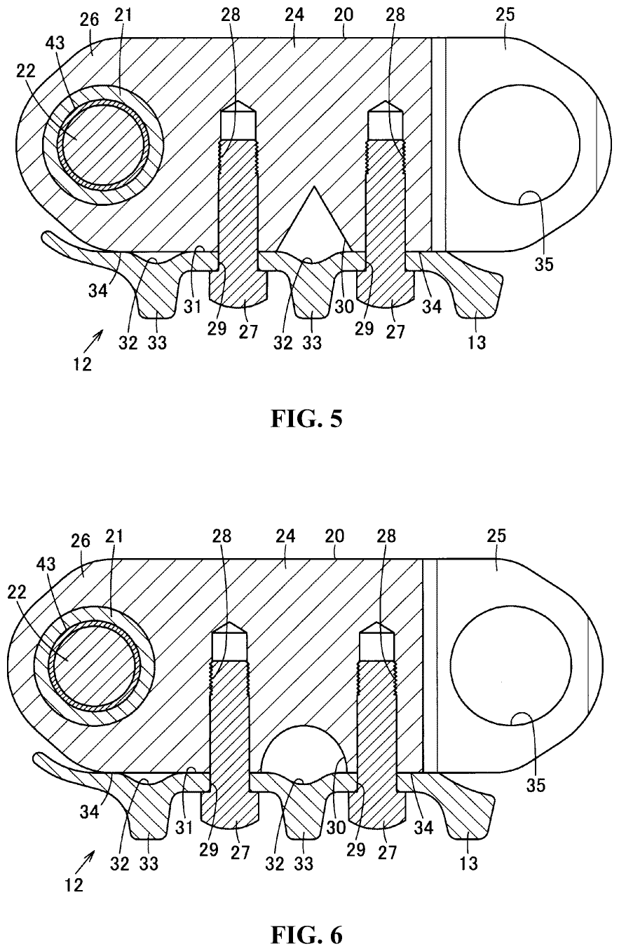

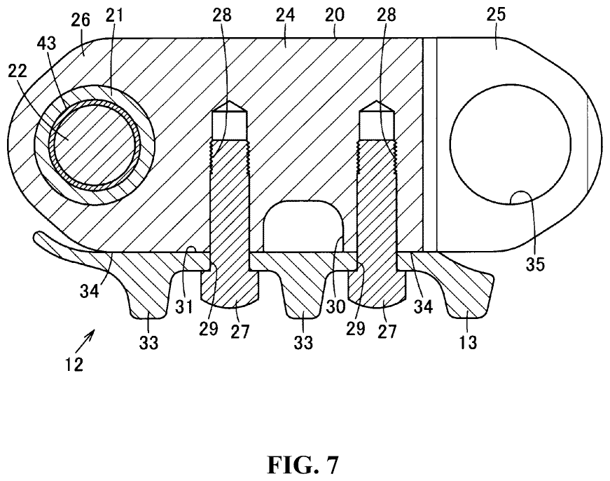

The present invention will be described in detail below based on a first embodiment shown in FIG. 1 to FIG. 4, a second embodiment shown in FIG. 5, a third embodiment shown in FIG. 6, and a fourth embodiment shown in FIG. 7.

First, the embodiment shown in FIG. 1 to FIG. 4 will be described.

In FIG. 4, 1 denotes a tracked vehicle. In the present embodiment, a hydraulic excavator, which is a working machine, is taken as an example of the tracked vehicle 1. In the tracked vehicle 1, an upper swivel body 3 is swivelably mounted on a lower traveling device 2, and a working device 4 and a cab 5 in which an operator is seated are mounted on the upper swivel body 3.

In the traveling device 2, sprockets 7 driven by a travel motor are respectively supported at ends of track frames 6 provided on left and right sides of a vehicle body, idlers 8 are rotatably supported on the other ends, respectively, a plurality of lower rollers 9 are rotatably supported on a low side portion, a plurality of upper rollers 10 are rotatably supported on an upside portion, and a track 11 is wound around the sprockets 7, the idlers 8, the lower rollers 9, and the upper rollers 10 on the left and right sides of the vehicle body.

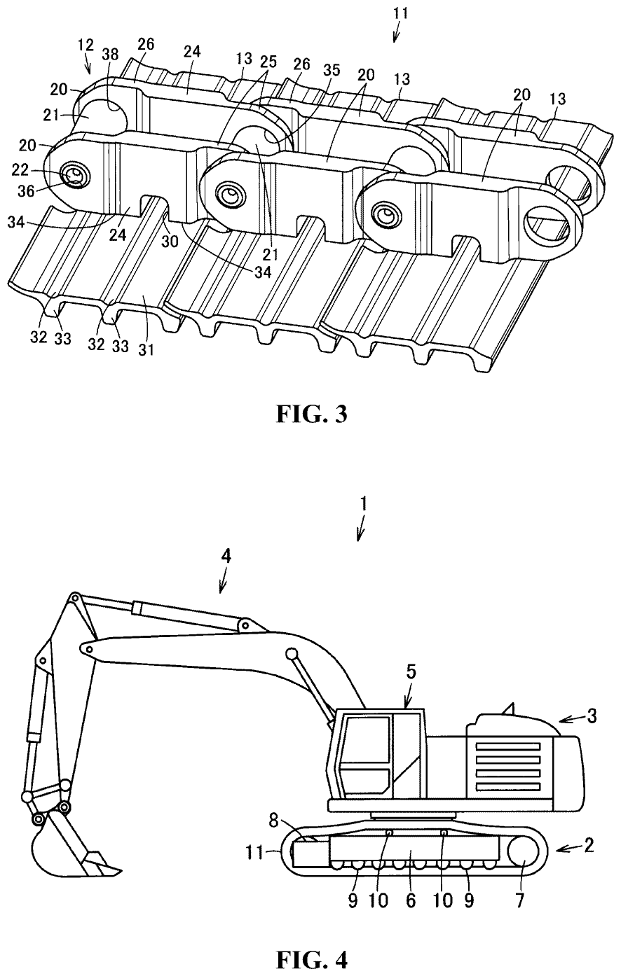

As shown in FIG. 3, the track 11 is formed by hanging and mounting shoe (shoe plate) 13, which is a rotating member, to an endless link device 12 that is symmetrical or approximately symmetrical. Further, the shoe 13 is driven to rotate by the link device 12.

The link device 12 is formed by coupling a plurality of plate-shaped links (track links) 20 to cylindrical bushes 21 and columnar pins 22. In the present embodiment, the plurality of links 20 are coupled in sequence to both ends of the bushes 21 and pins 22. Therefore, links 20, 20 that form a left-right pair are coupled to the other links 20, 20 that forms a left-right pair by the bushes 21 and pins 22. In other words, in the illustrated example, one link device 12 is set at a central portion of the shoe 13 in a left-right direction.

The links 20 shown in FIGS. 1 to 3 are disposed with a thickness direction as the left-right direction, a longitudinal direction as a front-rear direction, and a short direction or a width direction as an up-down direction. Each of the links 20 includes a flat plate-shaped link body 24 that is the thickest, and flat plate-shaped first and second coupling portions 25 and 26 that are thinner than the link body 24. The first coupling portion 25 and the second coupling portion 26 are located on opposite sides with respect to the link body 24. The first coupling portion 25 constitutes one end portion of the link 20, and the second coupling portion 26 constitutes the other end portion of the link 20. In the present embodiment, with respect to the link body 24, the first coupling portion 25 is offset in a step-like manner toward one side in the thickness direction, and the second coupling portion 26 is offset in a step-like manner toward the other end in the thickness direction. In other words, the first coupling portion 25 and the second coupling portion 26 are staggered in the thickness direction with respect to the link body 24.

The link body 24 is a portion that couples the link device 12 or the link 20 to the shoe 13. In the present embodiment, the link 20 and the shoe 13 are coupled to each other by mounting bolts 27, which are coupling members. In a side portion of the link body 24 facing the shoe 13, that is, a lower portion in FIG. 1, a bolt hole portion 28 having a threaded portion therein into which the mounting bolt 27 is screwed is formed from a lower portion to an upper portion along the up-down direction which is a perpendicular to a rotation axis direction of the link 20. In the illustrated example, the bolt hole portions 28 are formed on a first coupling portion 25 side, that is, one end side, and a second coupling portion 26 side, that is, the other end side, of the link body 24. The mounting bolt 27 inserted from a mounting hole 29 formed in the shoe 13 is inserted and screwed into the bolt hole portion 28, thereby coupling the link 20 to the shoe 13. Further, the bolt hole portion 28 extends beyond a central portion in the up-down direction in the link body 24 (link 20).

In the present embodiment, the bolt hole portions 28 are formed in pairs. In the illustrated example, the bolt hole portions 28 are formed apart from each other in pairs at one end side and the other end side of the link 20 in the link body 24.

Further, a hole portion 30 for earth removal from the track 11 and the link device 12 is formed in the link body 24. The hole portion 30 penetrates the link body 24 in the thickness direction. In other words, the hole portion 30 causes an inside of the link 20 to communicate with an outside thereof. The hole portion 30 divide an installation surface 34 of the link 20 to the shoe 13 into front and rear, which is a direction in which the shoe 13 rotates. The bolt hole portions 28 are respectively opened in the divided front and rear installation surfaces 34. Therefore, the hole portion 30 is formed between the bolt hole portions 28 in a side portion facing the shoe 13, that is, a lower portion in FIG. 1. For example, the entire hole portion 30 is located closer to the shoe 13 than the central portion of the link body 24 (link 20) in the up-down direction. The link 20 is formed in a portal shape by the hole portion 30. When the shoe 13 is mounted on the link 20, a flat surface 31 of the shoe 13 that faces the link 20 is in close contact with the installation surface 34 of the link 20, and thus an opening is formed with the surface 31 as one side by the hole portion 30.

A shape of the hole portion 30 may be any shape as long as the earth and sand can be efficiently discharged through the hole portion 30. In the present embodiment, the hole portion 30 is formed in a substantially rectangular shape having a width in the longitudinal direction of the link 20, and both corner portions thereof located away from the shoe 13 are curved in an arc shape. The hole portion 30 is formed so as not to be enlarged at least in a direction away from the shoe 13.

Preferably, the hole portion 30 is located in communication with a removal portion 32 formed in the shoe 13, and more preferably, in a position where a width center thereof coincides or nearly coincides with the removal portion 32. In other words, the link 20 and the shoe 13 are mounted such that the hole portion 30 communicates with the removal portion 32. The removal portion 32 is formed so as to reduce an amount of a material used for forming the shoe 13 without correspondingly reducing yield strength, and is also used for earth removal. The removal portion 32 is formed in a groove shape on the surface 31, and is linearly connected over an entire left-right width of the shoe 13. The removal portion 32 is formed so as to expand toward the link 20 side, for example. The removal portion 32 is also located, for example, behind a ground engagement protrusion (grouser bar) 33 formed on an outer surface of the shoe 13. In the present embodiment, a plurality of the removal portions 32 are formed on the shoe 13, and any one of these removal portions 32 is located in communication with the hole portion 30.

The first coupling portion 25 is also called an inner coupling portion, and is located on an inner side in the thickness direction of the plurality of links 20 coupled to one another. The second coupling portion 26 is also called an outer coupling portion, and is located on an outer side in the thickness direction of the plurality of links 20 coupled to one another. In other words, in the coupled links 20, the second coupling portion 26 of one link 20 is superimposed on an outer side of the first coupling portion 25 of the other link 20.

A first hole portion 35, which is a hole portion into which the bush 21 is press-fitted, is formed in the first coupling portion 25. The first hole portion 35 is formed in a circular shape and passes through the first coupling portion 25 in the thickness direction.

A second hole portion 36, which is a hole portion into which the pin 22 is press-fitted, is formed in the second coupling portion 26. The second hole portion 36 is formed in a circular shape and passes through the second coupling portion 26 in the thickness direction.

A recess 38 into which an end portion of the bush 21 is inserted is recessed and formed in a step-like manner around a periphery of the second hole portion 36. The recess 38 is formed along an outer periphery of the second hole portion 36 on an inside of the second coupling portion 26, that is, on a side facing the first coupling portion 25 of the other link 20.

The link 20 can be manufactured by any manufacturing method, but as an example, in the present embodiment, the link 20 is formed by cutting out from a long rolled material. A stepped shape in the thickness direction between the link body 24 and the first coupling portion 25 and second coupling portion 26 is formed by rolling when the rolled material is formed. From this rolled material, an entire shape of the link 20 can be obtained by simply cutting out only a peripheral portion at a width corresponding to a height of the link 20 using laser cutting or punching.

The first hole portion 35 and the second hole portion 36 may be machined either before or after the link 20 is cut out from the rolled material. The bolt hole portion 28 and the hole portion 30 are machined after the link 20 is cut out from the rolled material.

As shown in FIG. 2, the bush 21 is press-fitted between the first hole portions 35 of the left and right links 20. Both end portions of the bush 21 protrude from outer surfaces of the left and right links 20 and are inserted into side portions of the links 20 that are superimposed on outsides of the links 20, in the present embodiment, into the recesses 38.

The pin 22 is press-fitted between the second hole portions 36 of the links 20 that are superimposed on the outsides of the left and right links 20 through the bushes 21 that are press-fitted into the left and right links 20. The pin 22 is fitted into the bush 21 with a gap there between, and a lubricant 42 such as grease or lubricating oil is interposed in the gap, and the lubricant 42 is sealed by sealing the gap with a seal member 43.

The seal member 43 is a seal ring formed into an annular shape from an elastic member. The seal member 43 is sandwiched between an end portion of the bush 21 and the periphery of the second hole portion 36 of the link 20, in the present embodiment, a bottom portion of the recess 38.

Further, the link device 12 is assembled endlessly by sequentially connecting one link 20 and the other link 20 by press-fitting the bush 21 into the second hole portion 36 of the one link 20, fitting the recess 38 of the other link 20 into the end portion of the bush 21 so as to sandwich the seal member 43, and press-fitting the pin 22 through the bush 21 into the first hole portion 35 of the other link 20. The track 11 is formed by respectively mounting the shoe 13 on the links 20 of the assembled link device 12.

At this time, according to this embodiment, on the side portion of the link 20 facing the shoe 13, the bolt hole portions 28 are formed which respectively open onto the front and rear installation surfaces 34 divided by the hole portion 30 and into which the mounting bolts 27 for mounting the shoe 13 are screwed, and thus for example, even in the case of the track 11 for a large tracked vehicle, in which it is difficult to punch a hole portion for fastening the mounting bolt 27 to the link 20 with a nut, the shoe 13 can be easily mounted on the link 20 via the bolt hole portions 28. Since the link 20 can be formed to be thin and lightweight overall, the link 20 can be formed using the rolled material as the base material, which improves durability and productivity and reduces processing costs. Furthermore, the rolled material can also be made thin, which reduces a material cost, making it possible to provide a low-cost, inexpensive link 20.

On the other hand, when using a link 20 that does not have a hole portion for fastening a nut, it may be difficult to remove earth and sand that adheres to or accumulates when the tracked vehicle 1 travels on muddy ground and the like, by washing the vehicle.

Therefore, in the present embodiment, the hole portion 30 for earth removal is cut out and formed in the side portion of each link 20 facing the shoe 13 such that the installation surface 34 to the shoe 13 is divided into a plurality of parts in the rotation direction of the shoe 13. This allows the earth and sand that has accumulated between the links 20 to flow along the surface 31 of the shoe 13 mounted on the link 20, and to be effectively discharged through the hole portion 30.

Further, by making the link 20 symmetrical or nearly symmetrical from top to bottom, excluding the bolt hole portions 28 and the hole portion 30 which can be machined later, it is possible to machine both the left and right links 20 from the same rolled material, and therefore there is no need to prepare a dedicated rolled material for each of the left and right links 20, which further reduces the cost.

Then, in the link device 12 in which the plurality of links 20 are coupled endlessly, the shoe 13 is mounted on the side portion of each link 20 by screwing the mounting bolts 27 inserted through the pair of mounting holes 29 into the bolt hole portions 28 of the link 30, whereby the track 11 is formed. Thus, the track 11 that is inexpensive and has good maintenance properties against the earth and sand can be provided. Therefore, the chances of traveling with the earth and sand stuck between the links 20 can be reduced, and wear and damage of the parts of the traveling device 2 caused by the earth and sand and detachment of the track 11 can be prevented.

Furthermore, by forming the groove-shaped removal portion 32 on the surface 31 of the shoe 13 facing the link 20 and mounting the link 20 and the shoe 13 such that the hole portion 30 communicates with the removal portion 32, a large opening for discharging the earth and sand can be made. For example, when the track 11 is washed, water that flows into the removal portion 32 can be discharged through the hole portion 30 that opens a side surface thereof, making it easier to discharge the earth and sand.

The shape of the hole portion 30 may be set freely. For example, the shape may be a triangular shape in which a width gradually decreases from the shoe 13 side, as in an embodiment shown in FIG. 5, or may be a semicircular shape, as in an embodiment shown in FIG. 6. With these embodiments, the same effects as those of the first embodiment can be achieved.

Further, the removal portions 32 of the shoe 13 are not essential components, and for example, as in an embodiment shown in FIG. 7, the surface 31 of the shoe 13 facing the hole portion 30 of the link 20 may be flat.

Furthermore, in each embodiment, the shoe 13 is mounted on the link 20 via the mounting bolt 27, but the present invention is not limited thereto, and the shoe 13 may be mounted on the link 20 by welding or the like.

Further, the link device 12 is endless by sequentially coupling the links 20 of the same shape, but the present invention is not limited thereto, and one link 20 into which the bush 21 is fitted and another link 20 which is superimposed on the outside of the one link 20 and into which the pin 22 is press-fitted may be formed separately. In this case, a plurality of first hole portions 35 are formed in one link 20, and a plurality of second hole portions 36 are formed in the other link 20.

Further, the link device 12 is suitable for the track 11, but can also be applied to devices other than the track. For example, it is also possible to form a conveyor device for use in a work site and the like, by mounting rotating members such as a conveyor plate and a conveyor bar to the links 20 of the link devices 12 which are endlessly coupled.

### INDUSTRIAL APPLICABILITY

The present invention can be used in industries that manufacture and sell a track and links thereof for use in tracked vehicles such as a working machine.

1. A link on which a rotating member is mounted and which is used in a link device, comprising:
a hole portion for earth removal formed by cutting out a side portion facing the rotating member so as to divide an installation surface to the rotating member into a plurality of parts in a rotating direction of the rotating member.

2. The link according to claim 1, further comprising:
a bolt hole portion which is opened on each of the installation surfaces divided by the hole portion on the side portion facing the rotating member and into which a mounting bolt that mounts the rotating member is screwed.

3. A track comprising:
a link device in which a plurality of the links according to claim 1 are endlessly coupled; and
a shoe, which is the rotating member mounted on the side portion of each link.

4. The track according to claim 3, wherein
the shoe has a groove-shaped removal portion on a surface facing the link, and
the link and the shoe are mounted such that the hole portion and the removal portion communicate with each other.
